(19) United States
(12) Patent Application Publication
(10) Pub. No.: US 2003/0083891 A1
(43) Pub. Date: May 1, 2003

(54) Project Management tool

(76) Inventors: Kenny W. Lang, Katy, TX (US); Kristin Zembeck-England, Houston, TX (US)

Correspondence Address: BP AMERICA INC., DOCKET CLERK, BP LEGAL, M.C. 2207A, 200 E. RANDOLPH DRIVE, CHICAGO, IL, 60601-7125, US

(21) Appl. No.: 10/001,601

(22) Filed: Oct. 25, 2001

(51) Int. Cl. G06F 17/60

(52) U.S. Cl. 705/1

(57) ABSTRACT

A method and apparatus is disclosed for managing temporary personnel requirements. In one embodiment, the method comprises the steps of: listing a set of attributes for a plurality of tasks; acquiring a personnel data base of personnel skills/competences, wherein the personnel data base includes self-evaluations and factual information; using the factual information and the self-evaluations and picking individuals in the data base for inclusion into a pool of persons who are pre-qualified to perform at least some of the tasks; selecting a specific task and the attributes to perform the task; weighing the self-evaluated attributes of each of the individuals in the pool; and using at least the weighted self-evaluated attributes to match specific task attributes and identifying persons in the pool for hire.

### TECHNICAL FIELD

This invention relates to the general subject of business methods and systems and, in particular, to processes and devices for organizing and managing temporary personnel to perform technical and non-technical services.

### BACKGROUND OF THE INVENTION

In many technology areas, businesses are currently seeing a human resource shortfall. With technology demand increasing beyond existing resources, there is a strong need to acquire the right skills in a timely fashion to address business needs. Also, as a workforce continues to age, businesses will see even more of its highly experienced experts retire. This leaves them with not only a shortage of staff, but also a decrease in the depth and richness of its overall knowledge base.

The present invention is conveniently referred to as “TempSource.” It is designed as a systematic tool to assist a business in taking advantage of the knowledge and experience of those, outside of it, who already know the way it does work (e.g., retirees, consultants, etc.) while keeping the business in compliance with labor/legal policies on contracting with and/or hiring former employees and on co-employment

The motivation for the invention grew out of awareness of increasing demand for technical services in the oil and gas business beyond existing staff capacity, especially in a few critical strategic technology areas. Such businesses are now entering a phase of accelerated exploration and development and new technologies being applied to get the most out of existing assets. This requires more resources and specialized skills than currently exist within an upstream organization. Because high oil price conditions cannot be expected to last indefinitely, increased recruiting of full-time experienced persons is not an effective, sufficient, long-term solution.

One option, however, is to better leverage external expertise. With the proper plan and implementation, needed skills can be accessed and utilized without the impact of increasing current headcount which must then later be rationalized in a oil price downturn. In a sense, the total workforce can become mutable; keeping the internal workforce slightly understaffed and supplementing it with skills on a just-in-time, as-needed basis. This option will be not only more cost effective in the long run, but it should also have the added effect of increasing a sense of employment security of permanent staff.

When a collection of fully examined and pre-qualified candidates is defined, this resource can be tapped when business needs dictate. One advantage of establishing relationships with retirees or other technologists who are familiar to the organization is the inherent trust built in the relationship. This trust and familiarity can go a long way in decreasing the lag time in which the temporary worker can effectively contribute to a project team.

Identifying and having access to these individuals is not enough to make this a fully effective profitable proposition. However, by exploiting the capabilities of the Internet and web-based systems, the speed at which a person can be “recruited”, reviewed and “put to work hired” can be greatly increased. In contrast to using a recruitment middleman, more direct access to candidates also can greatly reduce the extra time and cost involved, and can create a greater sense of control over the process.

### SUMMARY OF THE INVENTION

In accordance with one aspect of the present invention, a method is disclosed for managing temporary personnel requirements. In one embodiment, the method comprises the steps of: listing a set of attributes for a plurality of tasks performed in a predetermined field of endeavor; acquiring a personnel data base of personnel skills/competences for a plurality of individuals, wherein the personnel data base comprises a plurality of individual records having self-evaluations of a plurality of the attributes and factual information; using at least the factual information and the self-evaluated attributes and picking individuals in the personnel data base for inclusion into a pool of persons who are pre-qualified to perform at least some of the tasks; selecting a task and a plurality of attributes to perform that task; weighing the self-evaluated attributes of each of the individual records of the personnel in the pool; and using the weighted self-evaluated attributes to match the selected task attributes and identifying persons in the pool for hire.

In another aspect of the invention, a tool is disclosed for managing re-occurring projects of a relatively short term duration for a long term business enterprise, wherein each project comprises jobs performed by skilled individuals. In one embodiment the tool comprises: a computer memory, a plurality of terminals that are linked to the memory by using the Internet; electronic personnel records comprising data fields that are stored in the memory, and a computer linked to said memory and programmed to read and process the data fields of the personnel records. One set of the terminals is used by individuals who are looking for work. Preferably, those individuals are retirees and previously employed persons. They insert job skills and competences into the data fields. Another set of the terminals is used by managers of the enterprise who insert either a negative subjective evaluation or an affirmative subjective evaluation into data fields of the personnel records. The computer is programmed to output a data base that is a function of a predetermined number of positive subjective evaluations and any negative subjective evaluations inserted into the individual personnel records. The computer is programmed to keep out of the data base any record having a negative subjective evaluation. Those records having positive subjective evaluations exceeding a predetermined number define a pre-qualified pool of candidates for hiring. Each short term job is specified by predefined graded skills and competences. The computer is programmed to assign a score to the records in the output data base, wherein the score is a function of the similarity of the graded skills to the skills and competences of the individuals in the output data base. Thus, the pre-qualified candidates are quickly identified to managers for hiring. E-mail can be used to quickly notify the selected candidates and furnish the details of the hiring process. In another embodiment of the invention, certain skills are graded as critical and the computer is programmed to identify only persons in the pool who have the critical skills as being candidates for hire.

The process and tool that are the subjects of the present invention have many immediate benefits:

Captures tried and trusted human resources to create a digital “rolodex”.

Shares trusted resources with other parts of the enterprise who have perhaps the same technology need, and likewise expose those resources to other aspects of the business.

Simplifies and standardizes the hiring process for both efficiency and managing potential co-employment and other legal liabilities.

Establishes stronger relationships with key retirees and independent consultants and optimizes their mutual benefits.

Staffs projects in a more strategic manner by variablizing a surplus workload to the open marketplace.

Reduces time and costs associated with using search firms to access consultants and independent experts.

Reduces time and costs associated with one-off establishment of contracting arrangements.

Enables easier tracking of temporary work being done to better prioritize man-hours, budgets, and manage staffing plans.

Numerous other advantages and features of the present invention will become readily apparent from the following detailed description of the invention, the embodiments described therein, from the claims, and from the accompanying drawings.

### BRIEF DESCRIPTION OF THE DRAWINGS

FIG. 1 is a schematic diagram of the invention;

FIG. 2 is a block diagram of the Application and Pre-qualification Process;

FIG. 3 is a block diagram of the Work Definition, Matching and Job Posting Process;

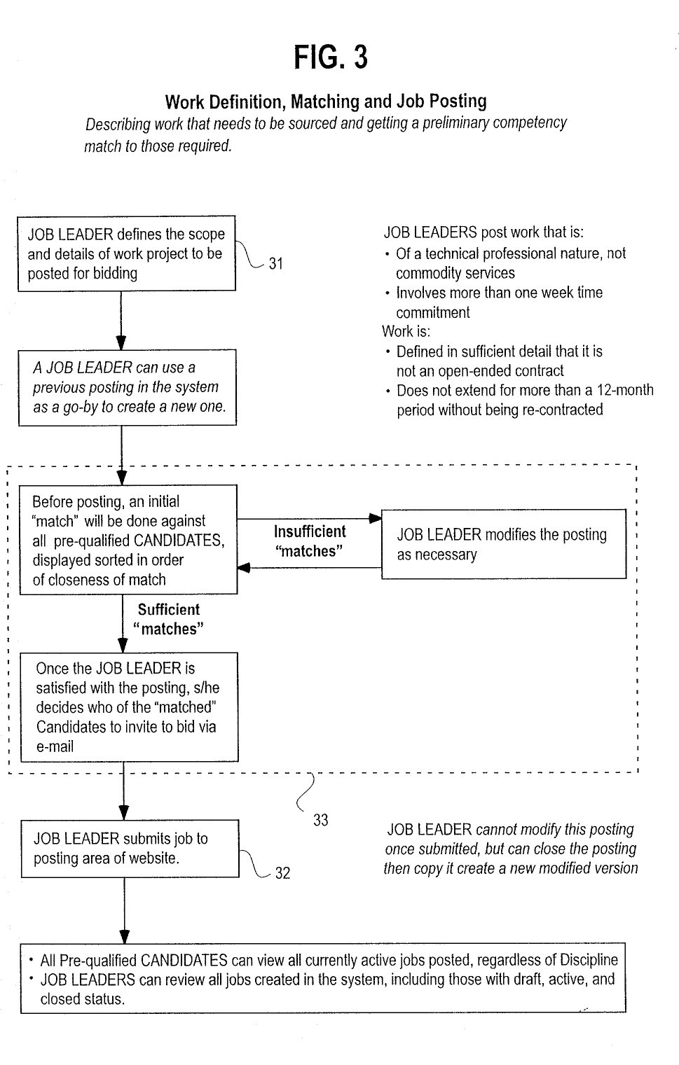

FIG. 4 is a block diagram of the Applicant Review and Candidate Engagement Process; and

FIG. 5 is a process diagram of one embodiment of the invention.

### DETAILED DESCRIPTION

Before proceeding to a description of the present invention, it must be remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

The following terms will be used:

TempSource is the name that has been given to the apparatus and method of the present invention by its owner BP America Inc.

A Job Leader or Team Leader is a manager or other full-time employee who has immediate responsibility for hiring temporary personnel and for specifying the qualifications of such persons.

A Candidate is a person or individual in the personnel supply pool who has been approved by the Qualification Board for the Applicant's primary Discipline.

A Project is a relatively short-term job or task for which the employer needs staff.

An Applicant is a person who is seeking employment and who has not been approved by the Qualification Board for the Applicants primary Discipline for entry into the Candidate Supply pool.

Skills and Competences are attributes or Discipline components that a person possesses or that a Job Leader needs for a Project.

Self-assessment is the process by which an Applicant and/or Candidate grades his or her own Skills and Competences (e.g., expert, skilled, basic, etc. and such levels of achievement may be evidenced by years of experience).

Qualification Board is a set of managers or employees who are skilled in one or more Disciplines and who qualify Applicants to Candidate status.

A job Discipline is a major specialty in a field of employment or endeavor. For example, in the exploration and production field of an oil and gas company, if the primary Discipline is “Drilling/wells”, the following Skills and Competences are components of that Discipline: Well Completions, Operations, Workover, Well Design, Artificial Lift, etc. Each of those components may be further specified (e.g., Workover skills include: design, control, slickline operations, snubbing, subsea intervention, etc.).

Overview

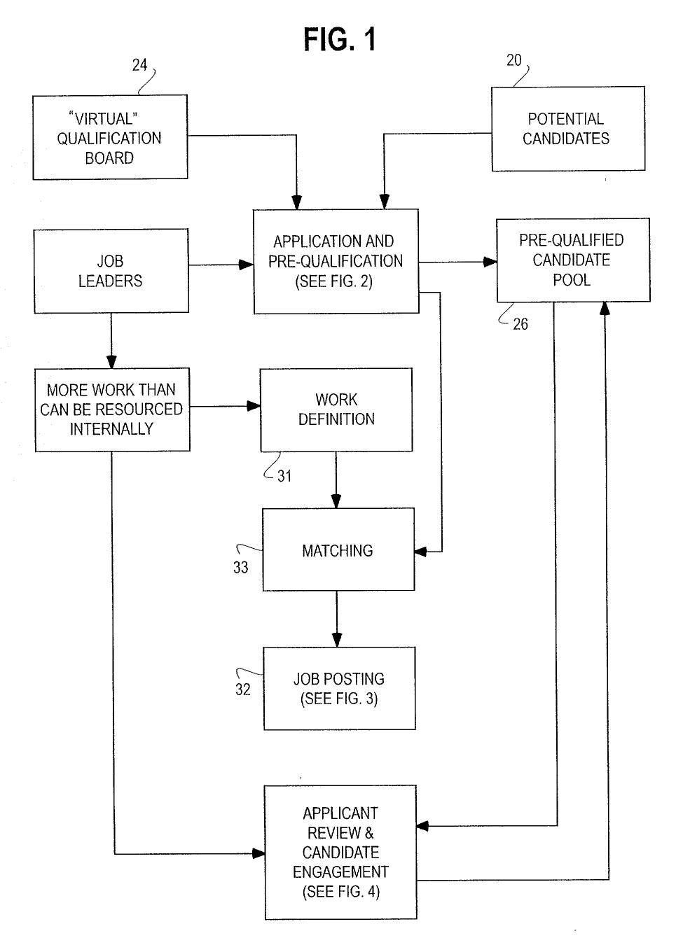

FIG. 1 illustrates the general framework of the invention. The main process components include: a Supply Pool 10 of pre-qualified skilled technologists who are identified as Candidates for future short-term Project assignments; a web-based data base and Computer System 12 to handle all major aspects of procuring temporary human resources; and a resource Demand Data Base 14 that is defined and managed by company employees.

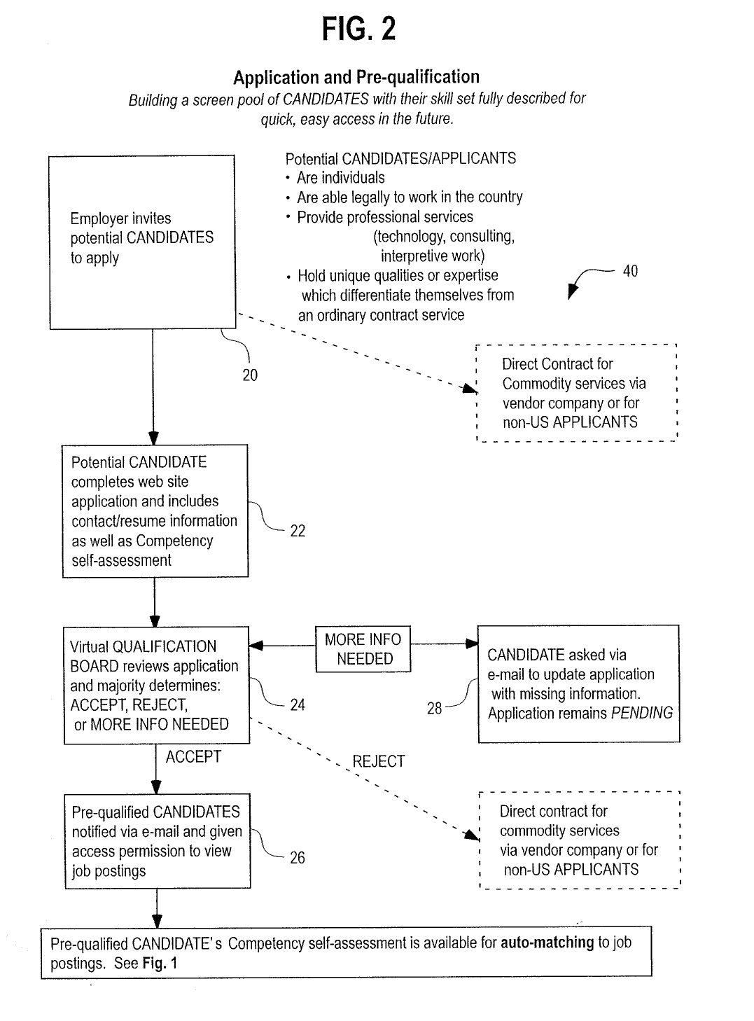

Turning to the Supply Pool 10, after selection as a Candidate, conditions of employment for a Project are pre-established and communicated to all Candidates. Potential Candidates have been screened as to their skills and competences by a Virtual Qualification Board. Interests of Candidates (e.g., type of Projects, availability, etc.) are captured in a computer memory 18 to allow system matching with human resource needs. Members of the Pool 10 can bid on as much or as little work as they would like. During exit interviews from full time employment, individuals leaving the employer (i.e., retirees, etc.) can be asked whether they want to be added to the Supply Pool and at that time have their skills assessed. Advertising 20 (traditional and by means of the Internet) may also be used to obtain Applicants for entry into the Pool (see FIG. 2).

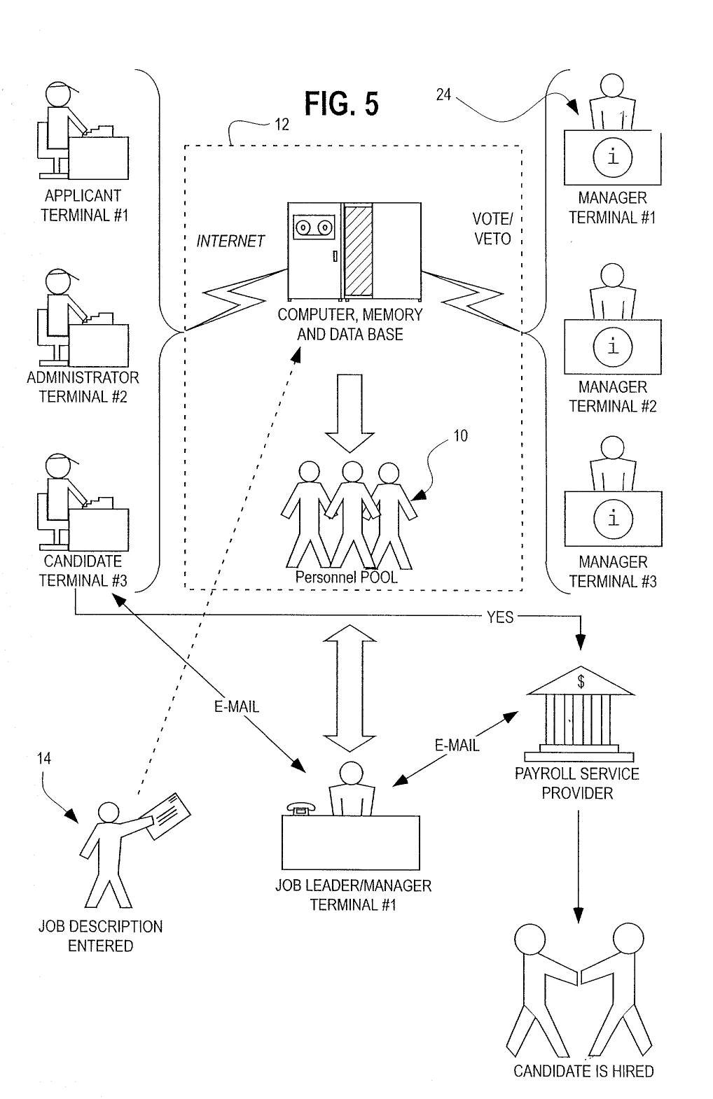

Turning to the web-based data base and Computer System 12, a computer 16 (see FIG. 5) is programmed to provide user-friendly online forms or displays to help define Project needs and Candidate skill sets. A consistent terminology is provided so that information can be easily correlated within the various parts of the system. E-mail is preferably used to notify pre-qualified Candidates. This allows Team Leaders to select “on-line” from the list of Candidate ‘bidders’ for Project work assignments. It facilitates notification to those persons being awarded the work and to the non-selected Applicants and Candidates. It may include a feedback system to capture a performance critique at the completion of a Project or employment term.

In one actual test of the TempSource system that was limited to the United States and that was limited to technical skills in oil and gas exploration and production business, a computer system was used that had the following characteristics:

| | Web Server | Data Base Server |
|---|---|---|
| Manufacture | Compaq | Compaq |
| Model | DL 380 | DL 580 |
| Processor | 266 MNz | 700 MNz |
| RAM | 1 GB | 2 GB |
| Disk Memory | Four 9 GB disks | Three 16 GB disks |

The operating system was Microsoft NT 4.0; and the program ran on a shared Microsoft NT SQLServer 7.0. Other operating conditions:

| Internet Connection: | WorldCom Tier 1 Backbone |
|---|---|
| Routers | Alteon Ace Director |
| Fire Wall | Nokia IP650 etc. |
| Internet capacity | 3 mbs, burstable to 100 mbs |
| Anticipated System capacity: | |
| Max Candidates | 120 |
| Max job definitions | 50 |
| Max simultaneous users | 40 |

The operations of the invention were performed by using HTML/Java Script, VBScript, Java and SQL software to create a plurality of interactive web-pages forming a relational data base. The computer was connected to the Internet or similar network using the Microsoft Explorer browser 4.0 (or later); Microsoft Internet Information Services 4.0 (or later); Microsoft Java Virtual Machine 5.00 (or later); and a Secure Socket Layer. Web pages made use of HTML/JavaScript and VB Script. Database procedures were performed using SQL and Database Connection Objects made use of Java.

Personal computers connected to the Internet are used as input/output terminals. The person programming the computer should take into account the recommendations of company professionals (e.g., legal, HR, technology, web systems, IT security, etc.). Central oversight should be maintained to capture and address any unforeseen problems and to facilitate communication. For example, labor attorneys should be consulted to understand: co-employment issues, options for establishment of a 3^{rd} party company or agency to address co-employment issues, and legal guidelines under which the process must operate. Labor attorneys can also: establish a simple standard pro-forma which represents the contractual relationship between the Candidate and the employer, both for Candidates entering the pool as well as for commencing temporary employment; determine standard compensation guidelines; and devise a payment process. Job Leaders in various Disciplines can help define a comprehensive list/hierarchy of Skills and Competences.

Finally, turning to the Resource Demand Side 14, Team Leaders identify resource or personnel needs, the skills required, and other job particulars (e.g., start date, estimated length of assignment, etc.). A brief description of the Project and associated tasks may also be provided. Team Leaders are responsible for making selections from interested pre-qualified Candidates and are accountable for any issues regarding their placement or working relationship. Preferably, Team Leaders will prompt performance feedback at completion of a Project and make a quick assessment of how well the system worked in getting demands met.

Applicants

Looking at TempSource from the eyes of a new Applicant, reference is made to FIG. 2. An Applicant would use a computer terminal or similar input/output device to log-on to the TempSource Internet web site. The TempSource web site includes a page displaying: “TERMS OF USE” and an “Acknowledgement” of those terms at the bottom of the display or screen; means for creating a User Account; means for establishing a password; and a menu item identified as “BEGIN REGISTRATION”.

The Applicant reads and acknowledges the agreement/terms of use (e.g., there are no guarantees, etc.) before final submission of the Qualification Form. The computer 16 is programmed to check the input form for completeness before it is accepted by the system. If an item of information is missing, the Applicant should be prompted to provide the missing information.

If “BEGIN REGISTRATION” is selected, the computer 16 is programmed to display a Qualification Form which prompts the Applicant through the six-step registration process 22 to input the following information:

a) Contact Info (e.g., name, address, etc).

b) Education (e.g., courses, schools, etc.).

c) Employment History (including prior employment with this employer and last date of full employment).

d) Skills and Competences.

e) Character/Professional References (i.e., multiple persons may be inserted).

f) Additional factual Information (e.g., language proficiencies, web site address, affiliation with third party temporary personnel contractor, etc.).

In the Skills and Competences section of the Registration Form, two options are provided:

“View All Competences” and

“Edit Competency”.

In View All Competences, the computer 16 is programmed to display skill assessments or ratings and number of years of experience in a read-only mode. This allows Applicant to see all the skills in a given Discipline. In one embodiment, the Discipline selected has Competences shown as section headers, component individual skills for each competency, self-graded skill levels and years of experience.

If the skills can be edited, an “Edit” link is available next to the Competency name. Clicking on this link will reload the displayed page with that Competency available for editing. If the skills cannot be edited, then the link is not displayed. The Edit Competency option allows the Applicant to edit a skill level and years of experience of a particular job skill. This mode also displays links to the different Competences in a Discipline. A link to “View All Competences” will reload the display page in the View All Competences option.

The Applicant selects the Discipline to be assessed. A primary Discipline can be selected from both page options. A check box next to a Discipline list box is provided that reads, “Make this my primary discipline.” When a primary Discipline has already been selected, the text reads: “This is my primary discipline” and, instead of a check box, an image of a “check mark” is displayed indicating that the current Discipline is the one selected as “primary”.

If data exists in the data base for the accessed Discipline, the data is shown in corresponding combo display boxes. If the Discipline has not been assessed, then “Select Years” and “Select Level” prompts are shown on all skills. The Applicant has the option to “save as a draft” if he/she wants to return later and finish the registration form. The Applicant may also have the option to print this form to fill out and return at a later time. The user must select a “contractor status” (e.g., Kelly Services, Clover Staffing, Independent etc.). The user must answer whether he/she worked for the prospective employer or one of its affiliates in the last two years and provide the company name and last date of employment, if the answer is “yes”.

If the user's application status is not “Pending”, then the user is allowed to edit the fields on this page.

Each item of information is recorded in data base fields stored in computer memory 18. After submission, the Applicant is returned to the “MAIN MENU” where the computer is programmed to provide the following options:

1. “My Profile” to allow an Applicant to review his or her Qualification Form and change profile data.

2. “Project Postings” to view available, posted Projects.

3. “Contacts” to send e-mail to TempSource administration.

4. “Terms of Use” to again review this information.

5. “Logout” to exit back to the “Login Screen”.

Programming Notes:

The default view is “View All Competences”.

All of the Competences and components for a Discipline are displayed dynamically based on the number of Competences and tasks in the data base for the Discipline. If there is data in the skills table for this person and Discipline, the skill level and years are shown. If there is no data for that Competency and task, the skill level and years are defaulted to “N/A”.

When the user selects another Discipline from a list box, a validation is performed on the current data and the data is added or updated in the data base. Then, all of the Competences and tasks for the newly selected Discipline are displayed dynamically based on the number of Competences and tasks in the data base for the selected Discipline.

The user checks a box if the Discipline being assessed is the primary Discipline. When the user saves this page, validation is performed to see if the user has already selected a different primary Discipline. If so, an alert message appears stating “You already have a primary Discipline. Do you want to change it?” Once a Discipline is chosen, the competences and tasks for that Discipline are displayed.

When proceeding to another page of the application form, the user clicks a “Continue” button, and his or her data is validated and posted in the data base with an application status of “Draft”.

If the input data does not pass validation, a confirm message stating the error is displayed, allowing the user to correct it.

The user can navigate between Competences in a Discipline by using the links in the “Edit Competency” mode.

A user may have skills rated in multiple Disciplines, but only one Discipline is the primary Discipline.

Qualification Board

Looking at TempSource from the eyes of a member of a Discipline Qualification Board, reference is made to FIG. 2. In one embodiment of the invention, each major job Discipline (e.g., Geosciences, Reservoir Engineering, Facilities & Operations, Engineering & Drilling/Wells—in the case of an oil and gas upstream enterprise) has its own Qualification Board, which reviews each Applicant for inclusion into the TempSource system. Their goal is to fill the Supply pool with pre-qualified talented individuals to help their business manage the peaks in its workload and to meet job demands in a timely manner without having to permanently increase the number of full time employees.

A Qualification Board member logs on to the TempSource system wherever he or she may be located by means of the Internet. The computer 16 is programmed to display a “MAIN MENU” for that member/user of the Qualification Board. From here, the member/user sees the following selections:

1. “View Candidates” where the user sees a list of Applicants who have submitted TempSource applications. These individuals will be listed in three categories:

(i) PENDING (i.e., Applicants awaiting action from the Qualification Board);

(ii) APPROVED (i.e., the individual's application is complete and has passed to Candidate status); and

(iii) DRAFT (i.e., application form is not complete).

2. “My Profile”—that is the profile information of the Qualification Board member who has logged into the system.

3. “Contact List”—Those individuals using TempSource as system administrators, Qualification Board members, Job Leaders, etc.

4. “Logout”.

By selecting “View Candidates,” each Applicant's name is displayed in hypertext that opens the information entered by that person 24. For each PENDING Applicant, each Qualification Board member has the option to vote or enter a subjective judgment as to the qualifications of the Applicant:

1. “Accept”. A positive subjective evaluation nominates that person 26 for inclusion in the Candidate/Supply Pool. In one version of TempSource, an Applicant is “approved” when 4 of 5 Qualification Board members approve that Applicant. The computer 16 is programmed to send an e-mail message to the Applicant that notifies him or her that he or she has been “approved” and has been entered into the Candidate/Supply Pool.

2. “Request More Information” 28. This generates an e-mail template that is addressed to the Applicant and provides for inputting text specifying what additional information is requested. A “blind copy” or a separately addressed e-mail may be mailed to other Qualification Board members.

3. “Reject”. In one version of TempSource, a rejection or “veto” of an Applicant by two Board members precludes that individual from becoming a Candidate for any job in that Discipline.

When a Qualification Board member has completed his or her review of Candidates and Applicants, he or she logs off the TempSource system.

Job Leader

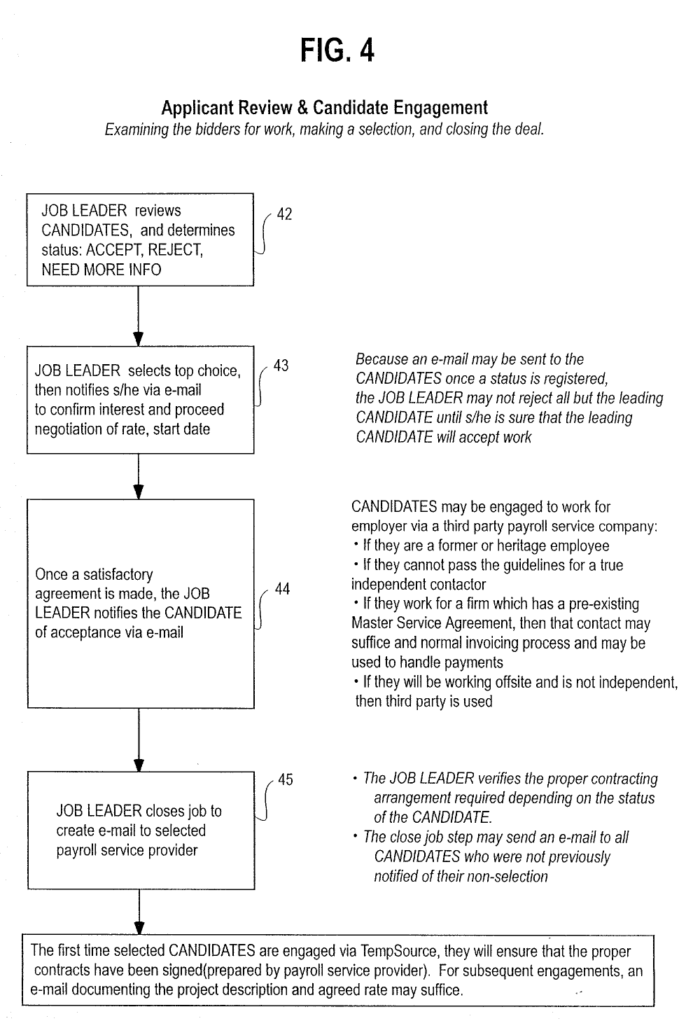

Looking at the TempSource system from the eyes of a Job Leader, reference is made to FIG. 4. Much as before, a Job Leader would log on to the system by using an input/output terminal to access the Internet and the TempSource web pages. The computer is programmed to display a graphical user interface. Six options are presented when a Job Leader logs on to the system:

1. “Main Menu” takes the user back to this opening window from any other window.

2. “Work Definition” 31 where new Project/information is entered, or previously defined Projects can be edited. Projects may be selected by either project name (from a drop-down menu), or by a project reference number (automatically generated when a new project is entered).

3. “Project Postings” which list existing Projects that are hypertext-linked to open up details of the Project.

4. “Contacts”—as before.

5. “Terms of Use”—as before.

6. “Logout”—as before.

“Work Definition” is selected to set up or edit a new Project into the TempSource system. Where setting up a “New Work Definition,” the Job Leader would enter the following information:

a) Project Title or name

b) Sponsor (e.g., Job Leader's name)

c) Project Function (e.g., production optimization)

d) Discipline (e.g., drilling/wells)

e) Location of Work

f) Description (i.e., a free-style narrative description)

g) Tasks & Responsibilities

h) Rate or Terms of Payment (e.g., lump sum, daily rate, etc.)

i) Travel Conditions (e.g., some, none, etc.)

j) Special Expectations & Requirements (e.g., access to hardware, software, additional disciplines, etc.)

k) Other Comments

l) Application Deadline Date

m) Project Start Date

n) Project End Date

o) COMPETENCES—uses the same format as that of the Applicant(Candidate pages in the application process. Competency may be checked as “CRITICAL”. Critical Competences are those which must be possessed by a Candidate as a condition for hiring.

Finally, after a Project has been defined, the Job Leader may select a “VIEW MATCHING CANDIDATES” button to search the TempSource system for Candidate matches 32 based on the Competency requirements.

Matching Algorithm

In one embodiment of the invention, the computer is programmed to provide a “VIEW MATCHING CANDIDATE” display that includes a percentage or score that is based on a matching algorithm. The percentage is representative of the number of Competences that the Candidate matches with those of the Project (i.e., 50% means that the Candidate matched half of the skills listed in the Work Definition). The algorithm in one embodiment is set up as follows:

1. Each job is given a “max score” based on the sum of the skill levels assigned by the Work Definition creator. Points were assigned as follows:

0=N/A (i.e., Non-Applicable)

1=Awareness

2=Basic Application

3=Skillful Application

4=Mastery

5=Expert

For instance, if three skills are required for a job: two at an “Awareness” level (2×1 point) and one at “Skillful Application” level (1×3 points), then the total or max value for that job is five points.

2. Each Candidate's Competency information is matched against the Project needs and each Candidate is given a specific point rating for the job. Those that have a point rating at 50% or greater than the max value for the job (and meet or exceed any skills that are deemed “critical”) are considered “matched” and appear on the Candidate list or data base for that job. Returning to the example of the previous paragraph, if the Candidate had all three required skills and all were self-evaluated as “Basic Awareness”, the Candidate has a total of six points and “matches” the skills needed for that job.

3. For skills defined as “critical” (i.e., must have, no exceptions) in the Work Definition form, the algorithm highlights this skill as a “required” skill and verifies that the Candidate has a skill level greater than or equal to the requested level. If a Candidate does not meet the requirement for the critical skill, that Candidate is excluded from the list, even if their total percentage is greater than 50%.

If the Job Leader selects “Project Postings” 41, the computer is programmed to show:

1) A list of the Job Leader's Projects entered into the TempSource system,

2) The status of each Project (Open, Closed, Withdrawn), and

3) The Candidates who have expressed interest in doing work for that Project (i.e., by selecting a hypertext “View”, the Job Leader can review the list of Candidates bidding for the Project).

Turning to FIG. 4, the Job Leader “actions” 42 each Candidate by entering one of the following choices:

1. Request for More Info 43—Opens up an e-mail window in which the Job Leader specifies what additional information is needed from that Candidate. For example, the Job Leader may open a negotiation over the dates of the work or the terms of compensation/Service fee.

2. Accept—The Candidate is notified that his or her bid is accepted 44. If so, the Job Leader would return to the Work Definition and “Close” the job 45. Closing the job and accepting a Candidate sets in motion the actual contracting process through a third party temporary service or payroll agency (e.g., Kelly Services, Clover Staffing, etc.). The enterprise's hiring department is also notified, and the process of signing a specific service agreement begins. An example of an acceptance letter template is shown below:

[image]

[image]

The user chooses the date by which the Candidate must respond. Send and Cancel buttons are provided at the bottom of the displayed page. The Job Leader clicks “Send” and an automatic e-mail is sent to the Candidate.

3. Reject—The Candidate is notified that his/her bid is rejected.

4. Declined—Job Leader makes this selection when a Candidate wishes to decline an offer on the indicated job after first being “accepted” for the job.

Frequently Asked Questions

1. Why would a business use TempSource and post a job through this process if a business already has the relationship built up with the contractor/consultant? Isn't this extra work?

Initially, yes; an extra step is needed both by the Job Leader and contractor Candidates, However, the objective is to build up the resources in the data base to capture the information on the Candidate for others in the Company to access/use those Candidates.

2. How do I get independent contractors to buy into this?

It provides more exposure, potentially more work assignments by increasing their company contacts and letting others get to know them. The contractor/vendor will also be able to view how many potential jobs in their area of expertise are out there.

3. Who invites persons to participate in TempSource?

A Qualification Board governs the administration for each major Discipline. The invitation process may vary within each of these Discipline areas. Some Disciplines may choose to allow any team member to invite candidates to register in TempSource while others may limit the invitations from the Qualification Board members themselves and Job Leaders.

4. How are potential candidates solicited?

Specific persons may be sent an invitation letter to register in TempSource. Direct advertising may also be used.

5. How are Candidates notified?

When the Job Leader posts a job, TempSource matches the job description criteria with the Skills and Proficiencies of the Candidates registered in the data base. The Job Leader clicks the button next to the name of the Candidates he/she is interested in. The TempSource system will send out e-mails to the Candidates chosen asking them if they are interested and available. The Job Leader makes the final selection, finalizes the terms of the job and enters relevant terms on the agreement.

6. What is the scope of TempSource?

The scope of this process is to include as potential Candidates any former employee/retiree who has been off the payroll at least 180 days, as well as external contractors and retirees/former employees from other companies. All Applicants will go through the same qualification process. Only qualified Applicants will be selected as Candidates to be part of the pre-qualified Supply Pool. TempSource is not a method for outsourcing. Its intent is to provide workforce flexibility without permanently affecting the cost structure of the organization. The Supply Pool of Candidates is considered an “extension” of the employer's business, not replacements or additions.

From the foregoing description, it will be observed that numerous variations, alternatives and modifications will be apparent to those skilled in the art. Accordingly, this description is to be construed as illustrative only and is for the purpose of teaching those skilled in the art the manner of carrying out the invention. Various changes may be made, functions substituted and features of the invention may be utilized. Here are just a few examples:

Add spell checking.

Expand to multiple countries and add more technical Disciplines.

Allow managers to supplement their resource needs directly rather than via a third party temporary service intermediary.

Expand competency framework and supply pool to non-technical Disciplines.

Expand the utilization of the system into other parts of the enterprise (e.g., chemical refining for an oil company).

Invite persons from consulting/contractor companies to apply for membership.

Do not allow the View Candidates link for a Project that does not have a bid or any matching Candidates. (This may slow down the generation of display pages because of the added data base check, and may nullify the ability of the manager to invite Candidates who have matched but not bid yet.)

Add a work load field to the Work Definition form.

Perform a batch process that removes Candidates that have not been matched and accepted a Project through the system during the last 12 months. These Candidates would receive an e-mail giving them 30 days notice that they will be removed from the system unless they reapply.

Convert existing consulting agreements into the TempSource Supply Pool.

Allow Candidates to enter their skills on new Disciplines as those are added to the system.

Add a Candidate history page: date account created, date Qualification Form was submitted, date Qualification Board approved person, current Project status, number of matched Projects, number of accepted Projects, number of rejected Projects, number of declined jobs, etc.

While the invention has been described in the context of a Work Definition having a single Discipline, one could apply these teachings to Work Definitions having multiple Disciplines. Similarly, while TempSource was designed for the qualification of individuals only, it could be revised to include consulting companies who register their individual clients. Moreover, the matching algorithm may be modified to exclude persons in the Supply Pool for an open job who have already been hired to perform another job.

Similarly, the programming of the computer may be modified to check that Candidates are “off” for 30 days after working for a year. This could be a batch process which purges Candidates and asks them to re-register or simply validate their status. One could assume that this 30-day-off period is a continuous 30 days within a 13-month period.

Finally, the programming may be modified to send an e-mail to a Job Leader when a Project is assigned to them by a system administrator and when another Job Leader is removed or reassigned.

Thus, it will be appreciated that various modifications, alternatives, variations, etc., may be made without departing from the spirit and scope of the invention as defined in the appended claims. It is, of course, intended to cover by the appended claims all such modifications involved within the scope of the claims.

We claim:

1. A process for managing temporary personnel requirements, comprising the steps of:
(a) listing a set of attributes for a plurality of tasks performed in a predetermined field of endeavor;
(b) acquiring a personnel data base of personnel skills/competences for a plurality of individuals, said personnel data base comprising a plurality of individual records, each of said records having self-evaluations of a plurality of said attributes and factual information;
(c) using at least said factual information and picking individuals in said personnel data base for inclusion into a pool of individuals who are pre-qualified to perform at least some of said tasks;
(d) selecting at least one task and a plurality of attributes to perform said one task;
(e) weighing said self-evaluated attributes of each of said individual records of personnel in said pool; and
(f) using at least said weighted self-evaluated attributes to match said plurality of one task attributes and identifying a person for hire in said pool of individuals.

2. The process of claim 1, wherein step (b) is performed by using a plurality of geographically separated input/output terminals that share a common communications network and that are accessible by said plurality of individuals.

3. The process of claim 2, wherein said personnel data base of step (b) is stored in a memory that is accessible by using said network.

4. The process of claim 3, wherein said network comprises the Internet.

5. The process of claim 2, wherein step (a) comprises the step of defining a plurality of data fields for recording information, including information representing personnel skills and task attributes; and wherein step (b) is performed by a person performing the steps of:
(i) accessing said data fields by using said terminals; and
(ii) posting information including said self-evaluation in said data fields.

6. The process of claim 2, where in step (e) the weight assigned to one attribute of one task is different than a weight assigned to another attribute of another task.

7. The process of claim 2, wherein step (c) comprises the steps of:
(i) providing a plurality of managers who have predetermined knowledge of said tasks of step (a) and predetermined knowledge of attributes for performing said tasks; and
(ii) using at least one of said managers and using one of said terminals to view said data base and to enter a vote on the qualifications of at least one individual in said personnel data base, wherein said vote is a function of said weighted skills/competences and said self-evaluated attributes.

8. The process of claim 7, wherein each manager enters a vote on at least one personnel record; and wherein said individuals are picked for inclusion into said pool, at least, by counting the votes of said managers.

9. The process of claim 8, wherein said pool comprises at least one individual who has received a majority of the votes of said managers.

10. The process of claim 1, wherein step (e) is performed by a data processor that has been programmed to access the data base of step (b) for the individuals in said pool and to assign a score to each of said individual's record as a function of the similarity of that individual's self-evaluated attributes to said attributes of said one task.

11. The process of claim 1, wherein said records include conditions of employment including dates of availability and service fee; and further including the steps of:
(g) using a manager to evaluate said matched persons of step (f) in view of that person's conditions of employment, said manager having predetermined limits on the dates for performing work and on fees for services; and
(h) communicating an offer to hire one person of step (f) who can work during said predetermined dates and for a fee not in excess of said limited fee for service.

12. The process of claim 3, wherein step (b) comprises the steps of:
(i) advertising for individuals to input personal skills and competences into said memory; and
(ii) providing a means for recording personal information into said memory.

13. The process of claim 12, wherein said step of advertising is performed by using an Internet web page.

14. The process of claim 12, wherein the individuals of step (i) have oil and gas exploration and production skills.

15. A temporary employment process for a business engaged in a plurality of employment disciplines and having full-time employees and managers, comprising the steps of:
(a) acquiring a data base of personnel attributes/competences by using a plurality of geographically separated input/output terminals that share a common communications network and that are accessible by individuals who have an interest in performing work tasks in an employment discipline of said business, said personnel data base comprising a plurality of personnel records that are stored in a computer memory in communication with said network and that information provided by using said terminals, each of said personnel records including a plurality of self-evaluated attributes/competences for at least one discipline;
(b) using a manager, who has predetermined knowledge of said tasks of step (a) and predetermined knowledge of attributes/competences for performing said work tasks and who uses an input/output terminal to access said records in said memory, and entering a vote into said data base as to the suitability of at least one person in said personnel data base for performing work tasks in said employment discipline;
(c) repeating step (b) at least one more time by using another manager to enter another vote with respect to said at least one person;
(d) counting the votes of said managers to select said at least one person from said personnel data base on the condition that said one person has received a majority of the votes of said managers of steps (b) and (c) and thereby defining pool of persons who are identified in said memory and who are pre-qualified to perform said work tasks in said employment discipline;
(e) identifying at least one temporary work task that is in said employment discipline and that requires a plurality of attributes/competences;
(f) weighing said attributes/competences of said persons in said pool by using a data processor that has been programmed to access said memory and to assign a score to each personnel record as a function of the attributes/competences identified in step (e);
(g) using said score to match said at least one temporary work task to said persons in said pool;
(h) using the information in said personnel data base for the persons of step (g) and indentifing a person for hire; and
(i) communicating an offer to hire to said identified person of step (h).

16. The process of claim 15, where said vote of steps (b) and (c) includes at least one negative vote that prevents any individual in said personnel data base from entering the pool of step (e).

17. The process of claim 15, wherein step (h) is performed by using an employee of the business who is guided by the results of step (g) and who subjectively evaluates the attributes/competences of said persons in said pool.

18. A tool for managing projects of a relatively short term duration for a long term business enterprise, each project comprising jobs performed by skilled individuals who are identified with at least one employment discipline, comprising:
(a) a computer memory, and a plurality of terminals that are located remotely from said memory and linked to said memory by using the Internet;
(b) a plurality of electronic personnel records having a set of predetermined data fields and stored in said memory, wherein at least one subset of said terminals is used by individuals to insert job skills and competences into predetermined data fields, and wherein another subset of said terminals is used by a predetermined number of managers of said enterprise who evaluate said skills and competences in said data fields and who individually insert at least one of a negative subjective evaluation and an affirmative subjective evaluation to at least one other predetermined data field of selected personnel records;
(c) a computer that is linked to said memory and that is programmed to read and display a plurality of said data fields; and
(d) an output data base obtained by using said computer and from at least some of said selected personnel records as a function of a predetermined number of positive subjective evaluations and negative subjective evaluations inserted into said selected personnel records, wherein said computer is programmed to prevent information from any record having a predetermined number of negative subjective evaluations inserted therein from entering said output data base, and wherein records having positive subjective evaluations exceeding said predetermined number define a pre-qualified pool of individuals eligible for hiring on short notice when a project job opening is created and without prolonged re-evaluation of all individual job skills and competences.

19. The tool of claim 18, further including notification means, using the Internet, for notifying at least some of said individuals in said output data base.

20. The tool of claim 19, wherein said notification means comprises e-mail.

21. The tool of claim 18, wherein said individuals of said supply data base comprise at least some persons who were previously employed in a full time capacity by the enterprise.

22. The tool of claim 21, further including a legal data base containing information describing conditions for employing individuals under a predetermined hiring conditions including whether or not such individual was previously employed by said enterprise and the dates of employment and the days that such person worked again for the enterprise; and wherein said computer is programmed to access said legal data base, to identify the date said individual left full-time employment by the enterprise, to read said conditions and to prevent records of said supply data base from entering said output data base if said hiring conditions are not satisfied.

23. The tool of claim 18, wherein said predetermined number of managers is five; wherein said predetermined number of positive subjective evaluations is four; and wherein said predetermined number of negative subjective evaluations is two.

24. The tool of claim 18, further including a demand data base of job attribute data including graded skills and competences to perform pre-defined tasks; and wherein said computer is programmed to assign a score to the records of said output data base, wherein said score is a function of the similarity of said graded skills to the skills and competences of the individuals in the output data base.

25. The tool of claim 24, where one pre-defined task comprises a critical skill; and wherein said computer is programmed to identify persons in said pool who have a skill the same as said critical skill as eligible for hire.

26. A process for employers to hire employees, comprising the steps of:
(a) using the Internet and soliciting persons to input personal skills/competences into a computer memory and seek employment;
(b) using the Internet and having at least some of the persons of step (a) to record personal information into said memory, said information including factual skills/competences and self-graded skills/competences, said memory comprising a plurality of data fields that digitally represent said skills/competences;
(c) using the Internet and having a plurality of current employees access said data fields of step (b) and evaluate said records and insert a vote into a data field of said personal records, said vote comprising one of an “accept” and a “reject”;
(d) using a computer to read said voted records of step (c) and flag those personnel records receiving at least three “accept” votes and no more than one “reject” vote to form a data base of persons screened for employment;
(e) entering into said memory a list of needed employee skills/competences;
(f) matching said needed skills/competences with said skills/competences in said data base of step (d) to produce a list of persons who are seeking employment and who have been evaluated as qualified for employment; and
(g) using the Internet and a supervisor skill set to screen said list of qualified persons in step (f) and to initiate a job offer to at least one of said persons by means of e-mail.

27. The process of claim 26, wherein step (f) is performed by mathematically matching said identified skills/competences of step (e) with the self-graded skills/competences of step (b).

28. A tool for managing personnel for a project, comprising:
(a) a demand data base containing a plurality of tasks requiring a plurality of predetermined skills;
(b) a supply data base containing a plurality of personnel records of persons not employed by the project, each record having factual information and having self-evaluations of a plurality of the skills to perform at least one of the tasks of said demand data base, and having individual evaluations of said information and said self-evaluated skills and wherein said individual evaluations are inserted by a plurality of current employees of the project;
(c) a processor that has been programmed to read and sort said individual evaluations in accordance with a pre-determined criteria;
(d) a pre-qualified data base formed by said processor from said supply data base and comprising those personnel records having at least a predetermined number of individual evaluations exceeding a pre-determined criteria and with regard to said skill levels inserted by the individuals; and
(e) a post-qualified data base formed by said processor from said pre-qualified data base and comprising those personnel records having self-evaluated skills matching the predetermined skills of selected tasks of step (a).

29. The tool of claim 28, wherein said individual evaluations of step (b) are one of an affirmative vote and a negative vote; and wherein said predetermined number of step (d) is at least three affirmative votes and not any negative votes.

30. The tool of claim 28, wherein said skills are graded over a predetermined numerical range; and wherein step (e) is preceded by the steps of expressing said self-evaluated skills as a numerical sum, expressing said predetermined skills of said selected task as a numerical total; and computing the ratio of said sum to said total.
